(19) United States
(12) Patent Application Publication
(10) Pub. No.: US 2010/0179289 A1
(43) Pub. Date: Jul. 15, 2010

(54) Method for the Production of Cyclic Polysiloxanes

(76) Inventors: Peter Cheshire Hupfield, Carmarthen (GB); Rachel A. Kneale, Rhoose (GB); David Clay Miller, Hanover, IN (US); Sarah O'Hare, Barry (GB); Avril Surgenor, Cardiff (GB); Richard Gregory Taylor, Penarth (GB)

Correspondence Address: DOW CORNING CORPORATION CO1232, 2200 W. SALZBURG ROAD, P.O. BOX 994, MIDLAND, MI, 48686-0994, US

(21) Appl. No.: 12/602,516

(22) PCT Filed: Jun. 3, 2008
(86) PCT No.: PCT/US08/65600

§ 371 Date: Dec. 1, 2009

Related U.S. Application Data
(60) Provisional application No. 60/944,175, filed on Jun. 15, 2007.

(51) Int. Cl. C08L 83/04

(52) U.S. Cl. 525/477; 525/474

(57) ABSTRACT

A process for producing cyclic polysiloxanes is disclosed. The first step of the process comprises combining a poiysiloxane, a cafaiyst and a high boiling endblocker, wherein the catalyst is selected from the group consisting of a phosphazene base and a carborane acid. The second step of the process comprises heating said poiysiloxane, catalyst and high boiling endblocker, and the third step of the process comprising recovering the cyclic poiysiloxane,

### CROSS-REFERENCE TO RELATED APPLICATIONS

None

### BACKGROUND K THE INVENTION

Commercial siloxane polymers are generally produced by the hydrolysis of dichlorosilanes. The hydrolysis generates a mixture of predominantly linear polysiloxanes with some cyclic polysiloxanes. The yield of the more commercially valuable cyclic polysiloxanes can be increased relative to linear polysiloxanes by performing the hydrolysis in a highly dilute solution, which improves the probability of cyclization versus oligomerization.

Several methods other than hydrolysis have also been reported to produce cyclic polysiloxanes. Most of these processes involve acid- or base-catalyzed thermal cracking or depolymerization of diorganopolysiloxanes. However, these processes have some issues associated with them which may include high reaction temperatures, long reaction and/or equilibration times, high corrosiveness, high polymer branching, and unfavorable ring size ratios. These issues reduce the efficiency and/or increase the costs and hazards associated with producing the desired cyclic polysiloxane.

The inventors herein have discovered a method of producing cyclic polysiloxanes that eliminates or reduces some of the problems associated with the prior art processes. The inventors have surprisingly found that by contacting a phosphazene or carborane acid catalyst with a polysiloxane and a high boiling endblocker, cyclic polysiloxanes can be continuously formed at reduced temperatures, with low levels of catalyst, with less corrosive reaction mixtures, with good yields, and with unexpected ratios of cyclic polysiloxane ring sizes.

### BRIEF SUMMARY OF THE INVENTION

A process for producing cyclic polysiloxanes is disclosed. The first step of the process comprises combining a polysiloxane, a catalyst and a high boiling endblocker, wherein the catalyst is selected from the group consisting of a phosphazene base and a carborane acid. The second step of the process comprises heating said polysiloxane, catalyst and high boiling endblocker, and the third step of the process comprising recovering the cyclic polysiloxane.

### DETAILED DESCRIPTION OF THE INVENTION

A process for producing cyclic polysiloxanes is disclosed. The first step of the process comprises combining a polysiloxane, a catalyst and a high boiling endblocker, wherein the catalyst is selected from the group consisting of a phosphazene base and a carborane acid. The second step of the process comprises heating said polysiloxane, catalyst and high boiling endblocker, and the third step of the process comprising recovering the cyclic polysiloxane.

The process of producing polysiloxanes according to the invention is believed to proceed through a mechanism wherein the polysiloxane first condenses to form a longer polysiloxane polymer. The polysiloxane polymer end-group then may react along its own polymer backbone forming a cyclic polysiloxane. The cyclic polysiloxane once formed can also react and reopen creating linear polysiloxane polymer. This equilibrium between linear and cyclic polysiloxane can be driven or shifted to produce more cyclic moieties by removing the cyclic polysiloxane from the reaction mixture as formed. One such means for removal is distillation or vaporization from the reaction mixture, which then can be followed by recovery of the cyclic polysiloxane distillate.

For the avoidance of any doubt, use of the concept of “comprising” herein means “containing”, “characterized by”, and “including”, and the use of the concept of “comprises” herein means “contains and and includes” and is meant to be inclusive of other elements or open-ended.

The term “about”, as used herein, is intended to mean approaching some exactness of quantity, number or measure.

The term “contacting”, as used herein, is intended to mean to bring components together such that they touch and/or commingle.

The nomenclature “Dₓ” as used herein is intended to mean a cyclic polysiloxane wherein each silicon in the ring is bonded to two oxygen atoms, and wherein x stands for the number of silicon atoms in the ring. The following structures are provided as examples of cyclotrisiloxane (D₃) and a cyclotetrasiloxane (D₄):

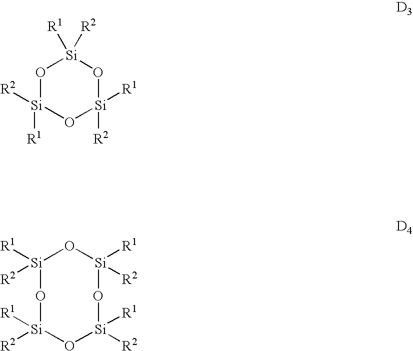

wherein R¹ and R² are independently hydrogen or a monovalent hydrocarbon radical, in another embodiment a monovalent C1-C6 hydrocarbon radical, in another embodiment a monovalent C1-C3 hydrocarbon radical, and in another embodiment a monovalent methyl radical.

The first step of the invention comprises contacting a polysiloxane with a catalyst selected from the group consisting of a phosphazene base and a carborane acid, and a high boiling endblocker. The polysiloxane can be contacted with the catalyst and high boiling endblocker by any applicable method known in the art for combining reactants. In one embodiment, the reactants are simply added sequentially to a reactor with mixing by any conventional means. In another embodiment, the reactants are contacted by metering together as part of a continuous process which contacts the reactants in the bed of a fluid bed reactor.

The polysiloxane of the first step of the invention may be any polysiloxane which can react via a condensation-type reaction and equilibrate to form cyclic polysiloxanes. The polysiloxanes, in general, are polymers with repeating units of a silicon atom bonded to an oxygen atom; two additional atoms, which may be part of a larger groups or the start of a polymer branch, are also bonded to the silicon in the repeat unit. In one embodiment of the invention, the polysiloxane is a silanol endblocked linear polysiloxane of formula HO(SiR³R⁴O)ₙH, wherein R³ and R⁴ are independently hydrogen or a monovalent hydrocarbon radical, in another embodiment a monovalent C₁-C₆ hydrocarbon radical, in another embodiment a monovalent C₁-C₃ hydrocarbon radical, and in another embodiment a monovalent methyl radical; and n is from 10 to 100, in another embodiment from 20 to 50, in another embodiment 25 to 35, in another embodiment about 30. In yet another embodiment, the polysiloxane is an alkoxy-endblocked linear polysiloxane of formula R⁵O(SiR³R⁴O)ₙR⁵, wherein IV is a C₈-C₂₀ monovalent hydrocarbon radical or a C8-C15 monovalent hydrocarbon radical, and R³, R⁴, and n are as defined above.

The first step of the invention comprises contacting the polysiloxane with a catalyst selected from the group consisting of a phosphazene base and a carborane acid, and a high boiling endblocker. In principle, any phosphazene base is suitable for use in this first step of the present invention. Phosphazene bases have the following core structure: P═N—P═N, in which free N valencies are linked to hydrogen, hydrocarbon, —P═N or ═P—N, and free P valencies are linked to —N or ═N. A wide range of suitable phosphazene bases has been described in Schwesinger et al, Liebigs Ann. 1996, 1055-1081, as well as U.S. Pat. No. 6,448,196, U.S. Pat. No. 6,353,075, and U.S. Pat. No. 6,284,859, whose descriptions are hereby incorporated by reference. Some phosphazene bases are commercially available from Fluka Chemie AG, Switzerland, In one embodiment, the phosphazene bases of the invention have at least 3 P-atoms. In another embodiment, the phosphazene bases have the following formulae:

((R⁶₂N)₃P═N—)ₓ(R⁶₂N)₃₋ₓP═NR⁷,

(((R⁶₂N)₃P═N—)ₓ(R⁶₂N)₃₋ₓP—N(H)R⁷)⁺(A⁻),

(((R⁶₂N)₃P═N—)_{y}(R⁶₂N)_{4-y}P)⁺(A), or

((R⁶₂N)₃P═N—(P(NR⁶₂)₂═N)_{z}—P⁺(NR⁶₂)₃(A)⁻

in which R⁶, which may be the same or different in each position, is hydrogen, a substituted hydrocarbon group, an unsubstituted hydrocarbon group, or a C₁-C₄ alkyl group, or in which two R⁶ groups are bonded to the same N atom may be linked to complete a 5- or 6-member heterocyclic ring; R⁷ is hydrogen, a substituted hydrocarbon group, an unsubstituted hydrocarbon group, a C₁-C₂₀ alkyl group, a C₁-C₁₀ alkyl group, or a t-butyl group: x is 1, 2 or 3, or in another embodiment 2 or 3; y is 1, 2, 3 or 4, or 2, 3 or 4; z is 0 to 10, or 0, 1, 2, 3 or 4; and A is an anion, preferably fluoride, hydroxide, silanolate, alkoxide, carbonate or bicarbonate. It will be clear to one skilled in the art that mixtures of the phosphazene bases herein described may be used.

Phosphazene bases are known to be strong bases which dissociate into ions very quickly in solution. Numerous phosphazene bases and routes for their synthesis have been described in the literature, for example in Schwesinger et al, Liebigs Ann, 1996, 1055-1081, EP1008611, and EP1008610. The compounds of the formula

((R⁶₂N)₃P═N—(P(NR⁶₂)₂═N)_{z}—P⁺(NR⁶₂)₃(A)⁻

described above may be made by a method which comprises reacting a phosphonitrile halide compound, preferably a phosphonitrile chloride, with a compound selected from a secondary amine, a metal amide and a quaternary ammonium halide to form an aminated phosphazene material, followed by an ion exchange reaction replacing the anion with a nucleophile. Phosphonitrile halide compounds and methods of making them are well known in the art; for example, one particularly useful method includes the reaction of PCl₅ with NH₄ Cl in the presence of a suitable solvent. In one embodiment, secondary amines are the preferred reagent for reaction with the phosphonitrile halide, and a suitable secondary amine has the formula R³₂NH, wherein R³ is a hydrocarbon group having up to 10 carbon atoms, or both R³ groups form a heterocyclic group with the nitrogen atom, for example a pyrollidine group, a pyrrole group or a pyridine group. In one instance, R³ is a lower alkyl group, preferably a methyl group. Examples of suitable secondary amines include dimethylamine, diethylamine, dipropylamine and pyrollidine. In one embodiment, the reaction is carried out in the presence of a material which is able to capture the exchanged halides, e.g. an amine such as triethylamine. The resulting by-product (e.g. triethyl ammonium chloride) can then he removed from the reaction mixture by, for example, filtration. The reaction may be carried out in the presence of a suitable solvent for the phosphonitrile chloride and phosphazene base. Suitable solvents include aromatic solvents such as toluene. The phosphazene material which is formed this way is generally then passed through an ion exchange reaction (preferably an ion exchange resin) whereby the anion is replaced with a hard nucleophile, preferably hydroxide or alkoxide, most preferably hydroxide. Suitable ion exchange systems include any known ion exchange systems such as ion exchange resins. The phosphazene is preferably dispersed in a suitable medium prior to passing through an ion exchange system. Suitable media include water, organic alcohol such as methanol, ethanol, and propanol, and mixtures thereof.

The amount of phosphazene base catalyst used in the first step of the invention may vary. In one embodiment, the amount of phosphazene base catalyst present in the reaction mixture is at least 10 parts per million (ppm) by weight; in another embodiment, the phosphazene base catalyst is present at at least 50 ppm; in another embodiment, the phosphazene base catalyst is present at at least 100 ppm; in another embodiment, the phosphazene base catalyst is present at at least 500 ppm; in another embodiment, the phosphazene base catalyst is present from about 10 ppm to about 2000 ppm; in another embodiment, the phosphazene base catalyst is present from about 50 ppm to about 1000 ppm; in another embodiment, the amount of phosphazene base catalyst is from about 100 ppm to about 1000 ppm; in another embodiment, the phosphazene base catalyst is present from about 250 ppm to about 1000 ppm; in another embodiment, the phosphazene base catalyst is present from about 250 ppm to about 500 ppm; in another embodiment, the phosphazene base catalyst is present from about 500 ppm to about 1000 ppm. The amount of phosphazene base catalyst required for the invention is influenced by the reaction conditions, such as temperature, pressure and feed rate, with the general trend of higher amounts of phosphazene base catalyst required as the temperature is reduced.

In one embodiment of the invention, the catalyst in the first step is a carborane acid. As used herein, “carborane acid” is intended to mean a compound comprised of boron, carbon, and hydrogen. In one embodiment, the carborane acid of the invention also comprises halogen.

Carborane acids according to the invention may be synthesized in various ways, one such way is by the reaction of a borane with acetylene either in the presence of a Lewis acid or at high temperature in the gas phase. The carborane acid catalyst of the invention may also be alkylated and may be, with respect to the arrangement of the atoms in its structure, the cage-, nest-, and/or web-type. In one instance, the carborane acid catalyst of the invention has the general formula [H][CBₙXₐH_{b}] wherein “n” is an integer from 3-11, a is 0 or an integer from 1-12, b is 0 or an integer from 1-12, provided that a+b=n+y, wherein y is an integer from 1-7 and n is as defined above, and “X” represents fluoro, chloro, bromo or iodo. In one instance, the carborane acid catalyst of the invention includes compounds preferably of the formulas: [H][CB₉H₁₀], [H]∂CB₉X₅H₅], [H][CB₁₁H₁₂], and [H][CB₁₁X₆H₆], wherein X represents fluoro, chloro, bromo or iodo. In another preferred embodiment, the carborane acid catalyst has a formula [H][CB₁₁Br₆H₆]. Alternatively, the carborane acid catalyst of the invention has the general formula [H][CBₙXₐR⁸₃] wherein “n” is an integer from 3-11, a is 0 or an integer from 1-12, b is 0 or an integer from 1-12, provided that a+b=n+y, wherein y is an integer from 1-7 and n is as defined above, “X” represents fluoro, chloro, bromo or iodo, and each R⁸ is independently either hydrogen or, optionally, alkyl or aryl.

The amount of carborane acid catalyst in he first step of the invention may vary. In one embodiment of the invention, the carborane acid catalyst is at a level of at least 10 ppm by weight; in another embodiment, the carborane acid catalyst is at a level of at least 50 ppm; in another embodiment, at a level of at least 100 ppm; in another embodiment, at a level from about 50 to about 1000 ppm; in another embodiment, at a level from about 75 to about 250 ppm; in another embodiment, at a level from about 75 to about 150 ppm; in yet another embodiment, at a level around 100 ppm. The actual level of carborane acid catalyst will vary depending upon the high boiling endblocker included and the reaction conditions with more catalyst required at lower temperatures and higher pressure.

Not to be limited by theory in any way, it is believed that the catalyst of the invention gives improved production and efficiency enabling continuous production of cyclic polysiloxane from non-cyclic or linear polysiloxane due to the catalysts' high basicity or acidity and weak conjugate acid or base. This high acidity or alkalinity of the catalyst produces high speeds of protonation or deprotonation of the other reactants. This allows for the fast formation of reactive species on a linear polysiloxane such as a silanolate group which can quickly react with its linear polysiloxane polymer backbone to form the desired cyclic polysiloxane. This speed of a protonation and deprotanation makes the production of cyclic polysiloxanes quick and, therefore, amenable to use as part of a continuous process.

The first step in the invention comprises contacting with a high boiling endblocker. The high boiling endblocker has a boiling point above that of the cyclic polysiloxane moieties to be produced. That is, the high boiling endblocker generally should have a boiling point above that of cyclic polysiloxanes comprising 3-7 siloxy units such as D₃-D₇ cyclics. In one embodiment of the invention the high boiling endblocker has the formula R¹SiR²₂OSiR²₂R¹, where each R¹ is independently C₆-C₁₂ alkenyl, C₆-C₈ alkenyl, hexenly, octenyl, C₆-C₁₂ alkyl, C₈-C₁₀ alkyl, octyl, dodecyl, alkaryl, arylalkyl, or cycloalkyl; each R² is independently C₁-C₄ alkyl, methyl, ethyl, propyl, or butyl. In one embodiment, the high boiling endblocker is dihexenyltetramethyldisiloxane, and in another embodiment the preferred high boiling endblocker is dioctyltetramethyldisiloxane. In an alternate embodiment, the high boiling endblocker is a high boiling alcohol of formula C_{z}H_{2z+1}OH, wherein z is 8-20 or, in another embodiment, 8-15.

The second step of the invention comprises heating the polysiloxane, the high boiling endblocker and the catalyst. The actual temperature at which the cyclic polysiloxane is produced from the mixture of starting materials may vary. In one embodiment the temperature of the reaction is 50° C. or greater; in another embodiment, the temperature of the reaction is 60° C. or greater; in another embodiment, the temperature is 100° C. or greater; in another embodiment, 150° C. or greater; in another embodiment, from about 50° C. to about 250° C.; in another embodiment, from about 60 to 240° C.; in another embodiment, from about 100° C. to about 210° C.; in another embodiment, from about 150° C. to about 200° C. The heat in the second step of the invention may be applied before, during and/or after mixing; however, the temperature is generally elevated once the polysiloxane, the high boiling endblocker, and the catalyst are contacted to drive the production of cyclic polysiloxane. The temperature required for optimum formation of cyclic polysiloxanes will depend on the type and amount of catalyst, the other reaction conditions such as pressure, the composition, amount and/or feed rate of the polysiloxane, and the composition of the high boiling endblocker. One skilled in the art would know how to adjust the temperature for the catalyst composition and the amount of phosphazene base or carborane acid catalyst to optimize the yield of cyclic polysiloxanes.

The pressure at which the equilibrium reaction is conducted and at which cyclic polysiloxane is produced may vary according to the invention. In one embodiment of the invention, the reaction pressure is less that 1000 mbar; in another embodiment, the reaction pressure is less that 500 mbar, in another embodiment, less than 100 mbar; in another embodiment, less that 50 mbar; in another embodiment, less than 25 mbar; in another embodiment, less than 20 mbar; in another embodiment, less than 15 mbar; in another embodiment, from about 0.5 to about 40 mbar; in another embodiment, from about 5 mbar to about 40 mbar, in another embodiment, from about 10 mbar to about 25 mbar; and in another embodiment, from about 10 mbar to about 20 mbar. The pressure conditions under which the equilibrium reaction is run affects the speed at which the cyclic polysiloxanes are removed from the non-cyclic polysiloxane materials. The general trend being that lower pressures remove cyclic polysiloxanes more quickly than higher pressures. Since the equilibrium of the reaction is shifted and cyclic polysiloxane formation is driven by the removal of the cyclic polysiloxane, the speed of removal of the cyclic polysiloxanes determines the speed or efficiency of the production of more cyclic polysiloxanes. Therefore, the pressure is adjusted to optimize cyclic polysiloxane production. One skilled in the art would know how to adjust the pressure conditions to optimize the production of cyclic polysiloxanes from the starting materials considering the other reaction conditions such as raw material percentage and temperature.

The third step of the invention is to recover the cyclic polysiloxane. According to one embodiment of the invention, the cyclic polysiloxane is removed from the reaction mixture as it is formed to drive the production of more cyclic polysiloxane. The removal of the cyclic polysiloxane from the other reactants can be effected, for example, by fractional distillation or vaporization of the cyclic polysiloxane from the reaction mixture. That is, as formed at higher temperature, the lower boiling cyclic polysiloxane boils and/or vaporizes leaving the liquid phase and entering the vapor phase. The gaseous or vaporized cyclic polysiloxane is then condensed into liquid form thereby separating and recovering the cyclic polysiloxane from the non-cyclic polysiloxane and other reactants. The distillation or vaporization of the cyclic polysiloxanes from the other reactants is driven by the elevated temperature and lower pressure reaction conditions.

The process of the invention may be carried out by contacting the catalyst, the high boiling endblocker and the polysiloxane in a film. The term “film” is meant to include the coating or spreading of a bulk liquid onto a surface so as to increase the surface area of the bulk liquid and thereby increase mass transfer of components from the liquid to a vapor phase. The phosphazene base or carborane acid catalyst, the high boiling endblocker, or the polysiloxane or any combination thereof may be preheated to a temperature below their boiling point prior to contact. The method of forming the film is not critical to the present process and can be any of those known in the art. The benefit of the present process is realized by the efficient transfer of heat and mass transfer within a film causing a rapid vaporization and removal of cyclic polysiloxane from the film. The vaporization and removal of cyclic polysiloxane from the film shifts the chemical equilibrium of the reaction to favor production of more cyclic polysiloxanes.

The film of reactants of the invention can be formed, for example, in a wiped film evaporator-type reactor. Examples of such reactors are described, for example, in Kirk-Othmer, Encyclopedia of Chemical Technology, Fourth Edition, Vol. 9, p, 965-968, (1994); and in Mehra, “Selecting Evaporators,” Chemical Engineering, Feb. 3, 1986, p. 53-72. As used in the examples of the invention, the reactor may be used as a multiple pass reactor, where materials exiting the reactor are recycled to the reactor to effect further reaction of the materials. By using the reactor as a multiple pass reactor and making the total starting reactants up to the original amount with additional polysiloxane, the creation of high molecular weight moieties by the process of the invention was investigated. The generation of high molecular weight species is undesirable because they increase the viscosity of the reactant mixture inhibiting the removal of the cyclic polysiloxane produced and thereby preventing the effective generation of cyclic polysiloxane from the other materials exiting the Wiped Film Reactor.

Film thickness and flow rates will depend upon such factors as minimum wetting rate for the surface on which the thin film is formed and the flooding point. One skilled in the art would know how to adjust the film thickness and flow rates for the reactor. Standard methods for determining these parameters are described, for example, in Perry et al., Perry's Chemical Engineers' Handbook, 6th ed., McGraw-Hill, N.Y., p. 5-59; and in York et al., Chemical Engineering Progress, October 1992, p. 93-98.

Cyclic polysiloxane formed as a result of the contact of the polysiloxane with the phosphazene base or carborane acid catalyst and the high boiling endblocker is vaporized from the film. Vaporization of the cyclic polysiloxane is effected by heating the thin film, by reducing pressure over the thin film, or by a combination thereof. It is preferred that vaporization of the cyclic polysiloxane from the film be effected by heating the film under reduced pressure. The film can be heated by standard methods, for example, passing a heated media such as a gas, water, or silicone oil through a jacket contacting the wall supporting the film. Generally, it is preferred that the temperature of the film be modified to balance optimal production of cyclic polysiloxane in time and yield with the negative of energy costs. The cyclic polysiloxane vaporized from the present process is removed from the reactor by standard methods, for example, venting and/or condensation and can be collected and used as a feed to other processes.

Some solvent may be optionally added to the process of the invention; however, the inventors have found that when the reactants are run through a Wiped Film Evaporator (WFE) at high solvent concentrations, high molecular weight moieties can be created which interfere with the removal, and therefore the production, of the cyclic polysiloxanes when the material exiting the reactor is recycled to the reactor to effect further reaction. Therefore, better yield and continuous reaction may be facilitated when the reaction mixture does not comprise large amounts of solvent. The solvent used herein may be high boiling, like the high boiling endblocker, so as to facilitate the removal of the cyclic polysiloxanes in the process. In one embodiment, the process of the invention includes the addition of solvent with the catalyst, high boiling endblocker, and polysiloxane; in another embodiment of the process of the invention consists essentially of producing cyclic polysiloxanes by contacting a phosphazene base catalyst, a high boiling endblocker, and a polysiloxane under heat and vacuum and with essentially no solvent present. Examples of solvents that may be used include the high boiling isoparaffins such as those sold under the trade name Isopar by Exxon.

In another aspect of the invention, the weight percent yield, as a percentage of the amount of material fed through the WFE, of cyclic polysiloxane produced according to the invention may vary. In one embodiment the percent yield of cyclic polysiloxane is greater than 40 percent; in anther embodiment the percent yield is greater than 50 percent; in another embodiment greater than 60 percent; in another embodiment greater than 60 percent; in another embodiment, greater than 70 percent; in another embodiment, greater than 80 percent; in another embodiment, greater than 84 percent.

In another aspect of the invention, the process of the invention produces a distribution, or mixture, of ring sizes of cyclic polysiloxane that is unexpected. The resulting cyclic polysiloxanes are higher in percentage of D₅. In one embodiment, the percentage of D₅ produced is greater than 15 weight percent of the cyclic materials produced according to the process of the invention; in another embodiment, the D₅ is greater than 18 percent; in another embodiment, the D₅ is greater than 20 percent; in another embodiment, the D₅ is greater than 22 percent; in another embodiment, the D₅ is greater than 24 percent; in another embodiment, the D₅ is greater than 36 percent; in another embodiment, the D₅ is greater than 28 percent.

The distribution, or mixture, of cyclic polysiloxane ring size may also be expressed as a ratio of D₅ to other cyclic polysiloxanes produced. In one embodiment, the D₅ to other cyclic polysiloxanes produced is in a ratio from 1:1, to 1:5; in another embodiment, the ratio is from 1:2 to 1:4; in another embodiment, the ratio is from 1:2.4 to 1:3.0; and in another embodiment, the ratio is from 1:2.5 to 1:3.0; in another embodiment, the ratio is from 1:2.5 to 1:2.8.

In another aspect of the invention, the process produces a distribution of cyclic polysiloxanes with low amounts of D₃. In one embodiment of the invention, the amount of D₃ produced as a percentage by weight of cyclic polysiloxane produced by the process of the invention is less than 10 percent; in another embodiment, the D₃ is less than 8 percent; in another embodiment, the D₃ is less than 5 percent; in another embodiment, the D₃ is less than 3 percent; in another embodiment, the D₃ is less than 2 percent; and in another embodiment, the D₃ is less than 1 percent.

The products of the process of the invention include D₃, D₄, D₅, D₆, and D₇ as defined above. Specific products include hexamethylcyclotrisiloxane, octamethylcyclotetrasiloxane, decamethylpentasiloxane, dodecamethylcyclohexasiloxane, tetradecamethylcycloheptasiloxane, 1,3,5-trimethylcyclotrisiloxane, 1,3,5,7-tetramethylcyclotetrasiloxane, 1,3,5,7,9-pentamethylcyclopentasiloxane, hexamethylcyclohexasiloxane, and 1,3,5,7,9,11,13-heptamethylcycloheptasiloxane.

### Examples

The following examples are included to demonstrate embodiments of the invention. It should be appreciated by those of skill in the art that the techniques disclosed in the examples which follow represent techniques discovered by the inventor to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the spirit and scope of the invention. Unless otherwise indicated, all percentages are in weight percent (wt. %).

To carry out the process of the invention a Wiped Film Evaporator (WFE), model KDL4, from UIC GmbH was used. The WFE allowed maximization of cyclic polysiloxane production by increasing the rate of removal of cyclic polysiloxane. To simulate a continuous process, the WFE was used as a multi-pass reactor, wherein the materials, or a portion thereof, exiting the evaporator were recycled to effect further reaction. The feed rate and the temperature and pressure in the reactor were varied to determine the effects on reaction rates and products.

The general procedure used in the examples follows. The high boiling endblocker and the polysiloxane were first mixed in a reaction flask and then the catalyst added. The mixture was then passed through the Wiped Film Evaporator for a first pass. The volatiles and polymer were collected and the volatiles analyzed by gas chromatography (GC). In some examples, polysiloxane was then added to the polysiloxane polymer, or a portion thereof, collected after the first pass through the WFE to reconstitute the polysiloxane polymer to the initial material weight before the first pass through the WFE. This reconstituted reactant mixture was then passed through the WFE for a second pass, and the polysiloxane polymer and cyclic polysiloxanes were collected again followed by analysis of the cyclic polysiloxanes by GC. A maximum of seven such passes through the WFE were made. However, in some examples, fewer passes were made through the WFE because cyclic polysiloxane production ceased (or was greatly reduced) or because the material exiting the reactor became too thick to successfully reconstitute and re-pass again through the WFE, in which case the experiment was stopped and abandoned before seven passes could be made. In some of the examples only a portion of the non-cyclic polysiloxane collected from the reactor from the previous pass was reconstituted to evaluate reduced levels of the catalyst present for the subsequent passes through the WFE.

In the examples containing a phosphazene base as the catalyst, a mixture of compounds according to formula (I) below were used as catalyst:

((R¹₂N)₃P═N—(P(NR¹₂)₂═N)_{z})—P⁺(NR¹₂)₃)(A)⁻ (I)

in which R1 is methyl, A is the hydroxide anion, and z is predominantly 0 to 3 with some smaller amount of compounds present with a z of 4-6.

### Examples 1a-1g

### Phosphazene Base Catalyst (I) and Dihexenyltetramethyldisiloxane Endblocker

Seven hundred grams of linear polysiloxane (HO(SiMe₂O)ₙH, wherein n averages 30) and 22 grams of dihexenyltetramethyldisiloxane were mixed in a reaction flask then 500 ppm of phosphazene base catalyst were added. The mixture was then run through the WET at 150° C., and the polysiloxane polymer and cyclic polysiloxane exiting the WFE collected and analyzed by gas chromatography (GC). In examples 1b, 1c, and 1e, the polysiloxane polymer collected from the previous WFE run was reconstituted to 700 grams with additional polysiloxane, and the reconstituted mixture run through the WFE. In examples 1d and 1f, the polysiloxane collected from the previous run was directly re-passed through the WFE without reconstituting the material to 700 g with additional polysiloxane. The results are in Table 1, infra.

TABLE 1

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 1a, | 1000 | 20 | 150 | 500 | D₃ = 4.2 | 50 |
| 1^{st} pass | | | | | D₄ = 54.4 | |
| | | | | | D₅ = 22.7 | |
| | | | | | D₆ = 4.1 | |
| 1b, | 1000 | 20 | 150 | 500 | D₃ = 4.2 | 77 |
| 2^{nd} pass | | | | | D₄ = 59.8 | |
| | | | | | D₅ = 27.8 | |
| | | | | | D₆ = 5.4 | |
| 1c, | 1000 | 20 | 150 | 500 | D₃ = 5.3 | 23 |
| 3^{rd} pass | | | | | D₄ = 55.6 | |
| | | | | | D₅ = 28.9 | |
| | | | | | D₆ = 6.3 | |
| 1d, | 2000* | 20 | 150 | 500 | D₃ = 2.6 | 79 |
| 4^{th} pass | (direct | | | | D₄ = 63.9 | |
| | recycle) | | | | D₅ = 27.5 | |
| | | | | | D₆ = 4.4 | |
| 1e, | 1000 | 20 | 150 | 500 | D₃ = 7.1 | 14 |
| 5^{th} pass | | | | | D₄ = 58.7 | |
| | | | | | D₅ = 25.0 | |
| | | | | | D₆ = 5.5 | |
| 1f, | 1000* | 20 | 150 | 500 | D₃ = 3.8 | 75 |
| 6^{th} pass | (direct | | | | D₄ = 66.3 | |
| | recycle) | | | | D₅ = 25.3 | |
| | | | | | D₆ = 3.7 | |

*polysiloxane polymer exiting from previous pass recycled through WFE without reconstituting the polysiloxane to the initial starting weight with additional polysiloxane.

### Examples 2a-2b

### Phosphazene Base Catalyst and Dioctyltetramethyldisiloxane High Boiling Endblocker

Five-hundred grams of polysiloxane (HO(SiMe₂O)ₙH, wherein n averages 30) and 15 grams of dioctyltetramethyldisiloxane high boiling endblocker were mixed in a reaction flask then 100 ppm of phosphazene base catalyst were added. This mixture was passed through the WFE at conditions of 150° C. and 10 mbar for example 2a. The polysiloxane and cyclic polysiloxane exiting the WFE were analyzed by gas chromatography (GC). For example 2b, half the non-cyclic polysiloxane collected from example 1a (1^{st} pass through the WFE) was made up to 500 g with polysiloxane and 7 g of the dioctyltetramethyldisiloxane high boiling endblocker then passed through the WFE at the conditions of 180° C. and 10 mbar. This gave 50 ppm phosphazene base catalyst from the polysiloxane polymer collected from example 2a in example 2b. The results are in Table 2, infra.

TABLE 2

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 2a, | 1000 | 10 | 150 | 100 | D₃ = 0.2 | 76 |
| 1^{st} pass | | | | | D₄ = 68.2 | |
| | | | | | D₅ = 26.5 | |
| | | | | | D₆ = 4.5 | |
| 2b, | 700 | 10 | 180 | 50 | D₃ = 6.4 | 60 |
| 2^{nd} pass | | | | | D₄ = 60.4 | |
| | | | | | D₅ = 26.1 | |
| | | | | | D₆ = 5.6 | |

### Examples 3a-3d (Comparative)

### KOH Base Catalyst and Dioetyltetramethyldisiloxane High Boiling Endblocker

Five-hundred grams of polysiloxane (HO(SiMe₂O)H, wherein n averages 30) and 15 grams of dioctyltetramethyldisiloxane high boiling endblocker were mixed in a reaction flask then KOH (0.25 g, 500 ppm in water 5 mL with 18crown6, 1.18 g 1:1 mixture) was added as catalyst. The mixture was passed through the WFE at 150° C. and 20 mbar pressure (10 mbar for examples 3c, 3d, and 3e). Poor separation of the cyclic polysiloxane was observed with non-cyclic polysiloxane carry over into the volatile cyclic polysiloxane collector. The temp was kept at 150° C., but when no cyclic polysiloxane was being removed, the pressure was dropped to 10 mbar, after which cyclic polysiloxane was condensed and collected. The polysiloxane collected was reconstituted to 500 g with linear polysiloxane and recycled through the WFE. In subsequent passes, the feed rate had to be reduced in addition to the reduction of the pressure to 10 mbar to get cyclic polysiloxane to be removed and condensed. After example 3e (the fifth pass through the WFE), the non-polysiloxane recovered was very viscous. The results are in Table 3.

TABLE 3

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 3a, | 1000 | 20 | 150 | 500 | N/A | — |
| 1^{st} pass | | | | | | |
| 3b, | 1000 | 20 | 150 | 500 | N/A | — |
| 2^{nd} pass | | | | | | |
| 3c, | 1000 | 10 | 150 | 500 | D₃ = 0.2 | 65 |
| 3^{rd} pass | | | | | D₄ = 70.5 | |
| | | | | | D₅ = 23.6 | |
| | | | | | D₆ = 4.5 | |
| 3d, | 400 | 10 | 150 | 500 | D₃ = 0.1 | 54 |
| 4^{th} pass | | | | | D₄ = 68.2 | |
| | | | | | D₅ = 24.4 | |
| | | | | | D₆ = 5.2 | |
| 3e, | 400 | 10 | 150 | 500 | D₃ = 1.4 | 31 |
| 5^{th} pass | | | | | D₄ = 68.5 | |
| | | | | | D₅ = 22.8 | |
| | | | | | D₆ = 5.0 | |

### Examples 4a-4g

### Phosphazene Base Catalyst and Dioctyltetramethyldisiloxane High Boiling Endblocker

Five-hundred grams of polysiloxane (HO(SiMe₂O)ₙH, wherein n averages 30) and 15 grams of dioctyltetramethyldisiloxane h boiling endblocker were mixed in a reaction flask then 500 ppm of the phosphazene base catalyst was added to this mixture. The mixture was then passed through the WFE at 150° C. 10 mbar. Volatile cyclic polysiloxane and non-cyclic polysiloxane polymer were collected. In the second pass a tenth of the polymer collected was made up to 500 g with linear polysiloxane and a further 15 g of high boiling endblocker and passed through the stripper for a run at 50 ppm phosphazene base catalyst at 190° C. and 10 mbar. All subsequent passes were conducted with 50 ppm phosphazene base catalyst and at 190° C. and 10 mbar. In example 4d (the fourth pass through the WFE), there was polymer carryover into the cyclic polysiloxane, so the volatile cyclic polysiloxane and non-cyclic polysiloxane were combined and re-passed twice until there was no non-cyclic polysiloxane in the volatile cyclic polysiloxane collected. The material collected for the fifth pass contained some high molecular weight material and was slightly lumpy. An additional 15 grams of the high boiling endblocker was added to the recycled material after the fifth pass and prior to the sixth pass. Branching in the final polymer was 108 ppm. Branching in the final cyclic polysiloxane collected was 51 ppm. The results for example 4a-4g are in Table 4.

TABLE 4

| | | | WFE | | Cyclics | Cyclics |
|---|---|---|---|---|---|---|
| Exam- | Feed Rate | Pressure | Temp. | Catalyst | Distribution | Yield |
| ple | (mL/hr.) | (mbar) | (° C.) | (ppm) | (wt. %) | (%) |
| 4a, | 1000 | 10 | 150 | 500 | D₃ = 0.2 | 70 |
| 1^{st} pass | | | | | D₄ = 67.2 | |
| | | | | | D₅ = 26.9 | |
| | | | | | D₆ = 4.8 | |
| 4b, | 1000 | 10 | 190 | 50 | D₃ = 7.1 | 60 |
| 2^{nd} pass | | | | | D₄ = 60.3 | |
| | | | | | D₅ = 25.5 | |
| | | | | | D₆ = 5.3 | |
| 4c, | 1500 | 10 | 190 | 50 | D₃ = 4.4 | 82 |
| 3^{rd} pass | | | | | D₄ = 62.6 | |
| | | | | | D₅ = 26.3 | |
| | | | | | D₆ = 5.4 | |
| 4d, | 1500 | 10 | 190 | 50 | D₃ = 1.1 | 83 |
| 4^{th} pass | | | | | D₄ = 67.3 | |
| | | | | | D₅ = 26.0 | |
| | | | | | D₆ = 4.7 | |
| 4e, | 1000 | 10 | 190 | 50 | D₃ = 5.6 | 54 |
| 5^{th} pass | | | | | D₄ = 61.4 | |
| | | | | | D₅ = 26.1 | |
| | | | | | D₆ = 5.3 | |
| 4f, | 1000 | 10 | 190 | 50 | D₃ = 5.6 | 69 |
| 6^{th} pass | | | | | D₄ = 59.5 | |
| | | | | | D₅ = 27.4 | |
| | | | | | D₆ = 6.0 | |
| 4g, | 1000 | 10 | 190 | 50 | D₃ = 6.3 | 68 |
| 7^{th} pass | | | | | D₄ = 60.4 | |
| | | | | | D₅ = 26.5 | |
| | | | | | D₆ = 5.5 | |

### Examples 5a-5d

### Phosphazene Base Catalyst and Dioctyltetramethyldisiloxane, High Boiling Endblocker

Five hundred grams of linear polysiloxane (HO(SiMe₂O)ₙH, wherein averages 30) and 15 grams of dioctyltetramethyldisiloxane boiling endblocker were mixed in a reaction flask, and 10 parts per million (ppm) phosphazene base catalyst were added. The mixture was passed through the WFE at about 150° C. and 10 millibar (mbar) pressure. Volatiles and polymer were collected but very little cyclics were formed. The product was passed through again with very little cyclics formation. Another 10 ppm of catalyst was added and passed again forming cyclics. Results are summarized in Table 5.

TABLE 5

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 5a, | 600 | 10 | 150 | 10 | — | 3 |
| 1^{st} pass | | | | | | |
| 5b, | 600 | 10 | 150 | 10 | — | 4 |
| 2^{nd} pass | | | | | | |
| 5c, | 600 | 20 | 150 | 20 | D₃ = 0.3 | 72 |
| 3^{rd} pass | | | | | D₄ = 69.5 | |
| | | | | | D₅ = 23.6 | |
| | | | | | D₆ = 4.5 | |
| 5d, | 600 | 20 | 150 | 20 | D₃ = 1.8 | 69 |
| 4^{th} pass | | | | | D₄ = 66.3 | |
| | | | | | D₅ = 25.0 | |
| | | | | | D₆ = 4.6 | |

### Examples 6a-6c

### Phosphazene Base Catalyst and Dioctyltetramethyldisiloxane High Boiling Endblocker

Linear polysiloxane (500 g) (HO(SiMe₂O)ₙH, wherein n averages 30) and dioctyltetramethyldisiloxane high boiling endblocker (15 g) were mixed in a reaction flask and phosphazene base catalyst added (100 ppm). The mixture was passed through the WFE at 150° C. 10 mbar for the first pass but very little cyclic polysiloxane was produced because of the stock polysiloxane polymer used to make up the reaction had been sitting in air for 3 days. The temperature was increased to 165° C. in the second and third passes at which point cyclic polysiloxane was generated. Volatile cyclic polysiloxane and non-cyclic polysiloxane were collected. Branching in final polymer was 89 ppm. The results are summarized in Table 6.

TABLE 6

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 6a, | 1000 | 10 | 150 | 100 | Not analysed | — |
| 1^{st} pass | | | | | | |
| 6b, | 1000 | 10 | 165 | 100 | D₃ = 6.2 | 43 |
| 2^{nd} pass | | | | | D₄ = 61.1 | |
| | | | | | D₅ = 26.3 | |
| | | | | | D₆ = 5.2 | |
| | | | | | D₇ = 1.2 | |
| 6c, | 600 | 10 | 165 | 100 | D₃ = 0.14 | 80 |
| 3^{rd} pass | | | | | D₄ = 65.1 | |
| | | | | | D₅ = 28.1 | |
| | | | | | D₆ = 5.6 | |
| | | | | | D₇ = 1.07 | |

### Examples 7a-7d

### Phosphazene Base Catalyst and Dioctyltetramethyldisiloxane High Boiling Endblocker

Five hundred grams of linear polysiloxane (HO(SiMe₂O)ₙH, wherein n averages 30) and 15 grams of dioctyltetramethyldisiloxane high boiling endblocker were mixed in a reaction flask and then 250 ppm of phosphazene base catalyst added. The mixture was passed through the WFE at 150° C. and 10 mbar, and the cyclic polysiloxane produced was collected and analyzed by GC. Final polymer branching was determined to be 611 ppm. The total cyclic polysiloxane produced was 1600 g, and the total polymer collected was 38 g with some losses on the glass in the WFE. The overall yield was 97%,

TABLE 7

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 7a, | 1000 | 10 | 150 | 250 | D₃ = 0.23 | 68 |
| 1^{st} pass | | | | | D₄ = 65.6 | |
| | | | | | D₅ = 27.7 | |
| | | | | | D₆ = 5.3 | |
| | | | | | D₇ = 1.0 | |
| 7b, | 1000 | 10 | 150 | 250 | D₃ = 0.4 | 72 |
| 2^{nd} pass | | | | | D₄ = 66.3 | |
| | | | | | D₅ = 27.2 | |
| | | | | | D₆ = 5.2 | |
| | | | | | D₇ = 1.0 | |
| 7c, | 1000 | 10 | 150 | 250 | D₃ = 0.04 | 67 |
| 3^{rd} pass | | | | | D₄ = 66.7 | |
| | | | | | D₅ = 26.8 | |
| | | | | | D₆ = 5.0 | |
| | | | | | D₇ = 0.96 | |
| 7d*, | 1000 | 10 | 150 | 250 | D₃ = 3.4 | 70 |
| 4^{th} pass | | | | | D₄ = 65.6 | |
| | | | | | D₅ = 25 7 | |
| | | | | | D₆ = 4.4 | |
| | | | | | D₇ = 0.7 | |
| 7e**, | 500 | 10 | 150 | 250 | D₃ = 0.27 | 85 |
| 5^{th} pass | | | | | D₄ = 74.0 | |
| | | | | | D₅ = 22.4 | |
| | | | | | D₆ = 2.9 | |
| | | | | | D₇ = 0.3 | |

*The polysiloxane polymer sample collected from the previous example was left in the air for 3 days and had hazy appearance. On passing through TFS with more polysiloxane it looked much more viscose, and some polymer carry over into the cyclic polysiloxane was observed.
**The polysiloxane polymer collected from the previous example was made up to 250 grams and stripped slowly and gave a low viscosity polymer fraction and cyclic polysiloxane as noted.

### Examples 8a and 8h

### Carborane Acid Catalyst [H][CB₁₁H₆Br₆] and Dihexenyltetramethyldisiloxane Endblocker

Five hundred grams of linear polysiloxane (HO(SiMe₂O)ₙH, wherein n averages 30) and 15 grams of dihexenyltetramethyldisiloxane high boiling endblocker were mixed in a reaction flask and then 100 ppm of carborane acid [H][CB₁₁H₆Br₆] were added (1 ml of an ethanol solution). This mixture was passed through the WFE at 150° C. and 20 mbar. No cyclic polysiloxane was able to be collected in the example 8a, so all the material was collected after the first WFE pass for example 8a and was re-passed through the WFE again for example 8b. Example 8b failed and was abandoned. No cyclic polysiloxane was recovered because of the thickness and gelling of the polysiloxane in the WFE. The reaction was abandoned. The results are in Table 8.

TABLE 8

| | Feed | | Cyclics | |
|---|---|---|---|---|
| | Rate | | Distribution | |
| Example | (mL/hr) | Cyclics Wt. (g) | (wt. %) | Polymer Wt. (g) |
| 8a, | 1000 | Very thick, gel- | — | Very thick with |
| 1^{st} pass | | like material from | | gum-like material |
| | | carry over all | | |
| | | mixed together | | |
| | | and re-fed | | |
| 8b, | | Gel formed and | — | Gel on walls of |
| 2^{nd} pass | | was carried over | | stripper. Reaction |
| | | into vols | | abandoned |

### Examples 9a-9g

### Carborane Acid Catalyst [H][B₁₁H₆Br₆] and Dioctyltetramethyldisiloxane High Boiling Endblocker

Five-hundred grams of linear polysiloxane (HO(SiMe₂O)ₙH, wherein n averages 30) and 25 grams of dioctyltetramethyldisoloxane high boiling endblocker were mixed in a reaction flask with mixing. One-hundred ppm carborane acid [H][CB₁₁H₆Br₆] catalyst were added (1 ml of an ethanol solution) to the mixture. The mixture was passed through a thin film stripper at 150° C. and 20 mbar. No or little volatile cyclic polysiloxane material was collected after the first, second and third passes through the WFE (example 9a, 9b, and 9c)), so the polysiloxane product from the WFE was collected and recycled through the WFE without further reconstitution for the examples following those runs. The feed rate was reduced to 500 mL/hr. for example 9d and more substantial amount of cyclic polysiloxane was produced giving a yield of 30 percent. Increasing the temperature to 190° C. for examples 9f and 9g ye cyclics yields of 79 and 80 percent.

TABLE 9

| | Feed | | WFE | | Cyclics | Cyclics |
|---|---|---|---|---|---|---|
| Exam- | Rate | Pressure | Temp. | Catalyst | Distribution | Yield |
| ple | (mL/hr.) | (mbar) | (° C.) | (ppm) | (wt. %) | (%) |
| 9a, | 1000 | 20 | 150 | 100 | — | — |
| 1^{st} pass | | | | | | |
| 9b, | 1000 | 20 | 150 | 100 | — | — |
| 2^{nd} pass | | | | | | |
| 9c, 3^{rd} | 1000 | 20 | 150 | 100 | — | — |
| pass | | | | | | |
| 9d, | 500 | 20 | 150 | 100 | — | 30 |
| 4^{th} pass | | | | | | |
| 9e, | 1000 | 20 | 190 | 100 | — | 47 |
| 5^{th} pass | | | | | | |
| 9f, | 1000 | 20 | 190 | 100 | — | 79 |
| 6^{th} pass | | | | | | |
| 9g, | 1000 | 20 | 190 | 100 | D₃ = 1.8 | 80 |
| 7^{th} pass | | | | | D₄ = 41.7 | |
| | | | | | D₅ = 33.4 | |
| | | | | | D₆ = 10.2 | |

That which is claimed is:

1. A process for producing cyclic polysiloxane, comprising the steps of
combining a polysiloxane, a catalyst and a high boiling endblocker, wherein the catalyst is selected from the group consisting of a phosphazene base and a carborane acid;
heating said polysiloxane, catalyst and high boiling endblocker to form a composition comprising a cyclic polysiloxane mixture; and
recovering the cyclic polysiloxane mixture.

2. The process of claim 1, wherein said recovering the cyclic polysiloxane step is conducted contemporaneously with said heating step.

3. The process of claim 1, wherein the phosphazene base catalyst comprises a compound selected from the group consisting of
((R¹₂N)₃P═N—)ₓ(R¹₂N)₃₋ₓP═NR²,
(((R¹₂N)₃P═N—)ₓ(R¹₂N)₃₋ₓP═N(H)R²)⁺(A⁻),
(((R¹₂N)₃P═N—)_{y}(R¹₂N)_{4-y}P)⁺(A⁻), and
((R¹₂N)₃P═N—(P(NR¹₂)₂═N)_{z}—P⁺(NR¹₂)₃)(A)⁻
in which R¹, which may be the same or different in each position, is hydrogen, an optionally substituted hydrocarbon group, a C₁-C₄ alkyl group, or is linked to another R¹ group and to the same N atom to complete a 5- or 6-member heterocyclic ring; R² is hydrogen, an optionally substituted hydrocarbon group, a C₁-C₂₀ alkyl group, a C₁ -C₁₀ alkyl group, or a t-butyl group; x is 1, 2 or 3; y is 1, 2, 3 or 4; z is 0 or an integer of from I to 10; and A is fluoro, hydroxide, silanolate, alkoxide, carbonate or bicarbonate; and
wherein the carborane acid is a compound selected from the group consisting of [H][CB₉R³₁₀], [H][CB₉X₅R³₅], [H][CB₁₁R³₁₂], and [H][CB₁₁X₆R³₆], in which X represents fluoro, chloro, bromo or iodo and each R³ represents independently hydrogen or C₁ to C₆ alkyl or aryl, and wherein the high boiling endblocker is dialkyltetramethyldisiloxane.

4. The process of claim 3, wherein the high boiling endblocker is a compound selected from the groups consisting of dihexenyltetramethyldisiloxane and dioctyltetramethyldisiloxane.

5. The process of claim 3, wherein the catalyst is a phosphazene base catalyst selected from the group consisting of
((R¹₂N)₃P═N—)ₓ(R¹₂N)₃₋ₓP═NR²,
(((R¹₂N)₃P═N—)ₓ(R¹₂N)₃₋ₓP═N(H)R²)⁺(A⁻),
(((R¹₂N)₃P═N—)_{y}(R¹₂N)_{4-y}P)⁺(A⁻), and
((R¹₂N)₃P═N—(P(NR¹₂)₂═N)_{z}—P⁺(NR¹₂)₃)(A)⁻
in which R¹, which may be the same or different in each position, is hydrogen, a substituted hydrocarbon group, a C₁-C₄ alkyl group, or is linked to another R¹ group and to the same N atom to complete a 5- or 6-member heterocyclic ring; R² is hydrogen, an optionally substituted hydrocarbon group, a C₁-C₂₀ alkyl group, a C₁-C₁₀ alkyl group, or a t-butyl group; x is 1, 2 or 3; y is 1, 2, 3 or 4; z is an integer of from 1 to 10; and A is fluoride, hydroxide, silanolate, alkoxide, carbonate or bicarbonate.

6. The process of claim 3, wherein the catalyst is a carborane acid selected from the group consisting of [H][CB₉H₁₀], [H][CB₉X₅H₅], [H][CB₁₁H₁₂], and [H][CB₁₁X₆H₆], in which X represents fluoro, chloro, bromo or iodo.

7. The process of claim 3 wherein the process is conducted at a temperature from about 50° C. to about 210° C.

8. The process of claim 7, wherein the temperature is from about 99° C. to about 195° C.

9. The process of claim 8, wherein the temperature is from about 150° C. to about 190° C.

10. The process of claim 9, wherein the process is conducted at a pressure from about 0.5 mbar to about 100 mbar.

11. The process of claim 10, wherein the pressure is from about 9 mbar to about 25 mbar.

12. The process of claim 9, wherein the pressure is from and including 10 mbar up to and including 20 mbar.
